(19) United States
(12) Patent Application Publication
(10) Pub. No.: US 2011/0142428 A1
(43) Pub. Date: Jun. 16, 2011

(54) MEDIA CONTROL ARRANGEMENT

(75) Inventor: Pär STENBERG, Veberod (SE)

(73) Assignee: Sony Ericsson Mobile Communications AB, Lund (SE)

(21) Appl. No.: 12/634,946

(22) Filed: Dec. 10, 2009

(51) Int. Cl. H04N 5/91; G06F 3/041; H04N 5/765; H04N 5/783

(52) U.S. Cl. 386/343; 345/173; 386/231

(57) ABSTRACT

A method and arrangement for controlling reproduction speed of media on a device is provided. A touch sensitive screen, wherein in a first operative mode a reproduction speed control signal is generated by displacing a pointing means on the touch sensitive screen, the displacement of the pointing means being responsive to a change in the reproduction speed of the media with a first ratio relative the displacement, the method including setting a second mode in which, the displacement of the pointing means is responsive to a change in the reproduction speed of the media with a second ratio relative the displacement.

### TECHNICAL FIELD

The present invention relates to a method and arrangement for controlling speed of a media played on a device having a touch-screen.

### BACKGROUND

Hand held devices, such as mobile phones, digital cameras, and pocket computers with graphical user interfaces have become increasingly popular in recent years. The most common example of a pocket computer is a smart phone, which may be embodied in various different forms.

Commonly hand held devices are also provided with play functionality for playing recorded video and audio. The graphical display is typically touch-sensitive and may be operated by way of a pointing tool such as a stylus, pen or a user's finger. Other devices rely more on a touch-sensitive display as the main input device and may thus have dispensed with a hardware keyboard.

The hand held device used as mobile terminals, i.e. in addition to providing typical pocket computer services such as calendar, word processing and games, they may also be used in conjunction with a mobile telecommunications system for services like voice calls, fax transmissions, electronic messaging, Internet browsing, etc. It is well known in the field that because of the noticeably limited resources of pocket computers, in terms of physical size, display size, data processing power and input device, compared to laptop or desktop computers, user interface solutions known from laptop or desktop computers are generally not applicable or relevant for pocket computers. One example is controlling play functionality, e.g. fast forward play/rewind of a content using a point device.

In devices having touch-sensitive screen, a so-called “progress bar” is used to visually indicate the progress of a lengthy operation or browsing media. The progress bar may be one of a number of styles, for example:
Segmented blocks that increase in steps from left to right.
A continuous bar that fills in from left to right.
A block that scrolls across a progress bar in a marquee fashion

In short, a progress bar is a component in a graphical user interface used to convey a degree of progress of a (e.g., computing) task, such as a download or file transfer, audio, or video play progress. The graphic may be accompanied by a textual representation of the progress in a percent format.

When a user watches or listens to a relatively lengthy media file and wants to move to another location on the media, the progress bar may be used. In a touch-screen interface the user can often press the active progress-bar position and then move to a new position, which effects the media corresponding to the new position. The problem is that the length of the progress bar is usually scaled to correspond to the total length of the media file (1:1 relation). If the user is watching or listening to a relatively lengthy media file, e.g., audio files or movies, a small position change of the finger, on the progress bar, results in big change in the corresponding time position in the media. Thus, it is problematic to make precise changes, within the media content, using a progress bar that is “to scale.”

### SUMMARY

One embodiment of the present invention provides means for controlling media with more accuracy and ability to fine tune fast forward and/or rewind of the media file.

For these and other reasons, a method of controlling reproduction speed of a media on a device, which comprises a touch sensitive screen. In a first operative mode a reproduction speed control signal is generated by displacing a pointing means on said touch sensitive screen, said displacement of said pointing means being responsive of a changing of said reproduction speed of the media with a first ratio relative said displacement. The method comprises setting a second mode in which, said displacement of said pointing means is responsive of a changing of said reproduction speed of the media with a second ratio relative said displacement. The second mode is initiated by a user, media or automatically.

The ratio may be Δt=n×Δd, wherein Δd is the displacement distance of the pointing means on the touch sensitive screen, Δt is the change of time in the media corresponding to said speed and n is a factor for changing the ratio between pointing means movement and rate of speed of the media. The displacement is applied on an active area, which is configured as a progress bar and related to a media length and used to control media reproduction. The reproduction speed of the media with a second ratio relative said displacement is set when moving said pointing means in direction deviating from said movement of the pointing means on said touch sensitive screen. According to one embodiment, the active area is a progress bar related to a media length and used to control media reproduction and the second rate of speed is set when moving a pointing means in a direction deviating from said movement of the pointing means on said touch sensitive screen and a distance between said progress bar and a point of contact between said pointing means and the touch sensitive screen changes said second ratio. The reproduction speed may be one of fast forwarding or rewinding of said media.

The invention also relates to a device including a touch sensitive screen, a memory for storing a media, and a first control unit for controlling said screen, a second control unit for reproducing said media on said touch sensitive screen. The second control unit is configured to in a first operative mode to set a reproduction speed control signal generated due to displacement of a pointing means on said touch sensitive screen, said displacement of said pointing means being responsive of a changing of said reproduction speed of the media with a first ratio relative said displacement, and to set a second mode in which, said displacement of said pointing means is responsive of a changing of said reproduction speed of the media with a second ratio relative said displacement. The device may be one of a mobile terminal, telephone, a digital media player, a camera, a personal digital assistant (PDA), a computer or a device with content displaying and touch screen capability. The media may be audio and/or video media. The reproduction speed is fast forwarding or rewinding of said media. The media may represent content accessed from an external device. The second mode is initiated by a user, the media, or automatically.

### BRIEF DESCRIPTION OF THE DRAWINGS

Reference is made to the attached drawings, in which elements having the same reference number designation may represent like elements throughout.

FIG. 1 is a diagram of an exemplary system in which methods and systems described herein may be implemented;

FIG. 2 illustrates a schematic view of a user interface according to an embodiment of the invention,

FIG. 3 is a flow diagram illustrating exemplary processing by the system of FIG. 1,

FIGS. 4a to 4e illustrate the operation of a user interface according to an embodiment of the present invention,

FIGS. 4a to 4c illustrate schematically technical aspects according to an embodiment of the present invention, and

FIG. 6 illustrates schematically a communication device according to an embodiment of the present invention.

### DETAILED DESCRIPTION

The following detailed description refers to the accompanying drawings. The same reference numbers in different drawings may identify the same or similar elements.

The term “image,” as used herein, may refer to a digital or an analog representation of visual information (e.g., a picture, a video, a photograph, animations, etc).

The term “audio” as used herein, may include may refer to a digital or an analog representation of audio information (e.g., a recorded voice, a song, an audio book, etc).

Also, the following detailed description does not limit the invention. Instead, the scope of the invention is defined by the appended claims and equivalents.

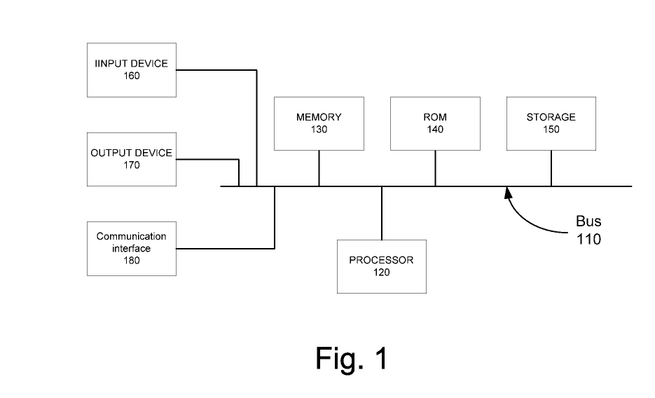

FIG. 1 is a diagram of an exemplary system 100 in which methods and systems described herein may be implemented. System 100 may include a bus 110, a processor 120, a memory 130, a read only memory (ROM) 140, a storage device 150, an input device 160, an output device 170, and a communication interface 180. Bus 110 permits communication among the components of system 100. System 100 may also include one or more power supplies (not shown). One skilled in the art would recognize that system 100 may be configured in a number of other ways and may include other or different elements.

Processor 120 may include any type of processor or microprocessor that interprets and executes instructions. Processor 120 may also include logic that is able to decode media files, such as audio files, video files, multimedia files, image files, video games, etc., and generate output to, for example, a speaker, a display, etc. Memory 130 may include a random access memory (RAM) or another dynamic storage device that stores information and instructions for execution by processor 120. Memory 130 may also be used to store temporary variables or other intermediate information during execution of instructions by processor 120.

ROM 140 may include a conventional ROM device and/or another static storage device that stores static information and instructions for processor 120. Storage device 150 may include a magnetic disk or optical disk and its corresponding drive and/or some other type of magnetic or optical recording medium and its corresponding drive for storing information and instructions. Storage device 150 may also include a flash memory (e.g., an electrically erasable programmable read only memory (EEPROM)) device for storing information and instructions.

Input device 160 may include one or more conventional mechanisms that permit a user to input information to the system 100, such as a keyboard, a keypad, a directional pad, a mouse, a pen, voice recognition, a touch-screen and/or biometric mechanisms, etc. Output device 170 may include one or more conventional mechanisms that output information to the user, including a display, a printer, one or more speakers, etc. Communication interface 180 may include any transceiver-like mechanism that enables system 100 to communicate with other devices and/or systems. For example, communication interface 180 may include a modem or an Ethernet interface to a LAN. Alternatively, or additionally, communication interface 180 may include other mechanisms for communicating via a network, such as a wireless network. For example, communication interface may include a radio frequency (RF) transmitter and receiver and one or more antennas for transmitting and receiving RF data.

System 100, consistent with the invention, provides a platform through which a user may play and/or view various media, such as music files, video files, image files, games, multimedia files, etc. System 100 may also display information associated with the media played and/or viewed by a user of system 100 in a graphical format, as described in detail below. According to an exemplary implementation, system 100 may perform various processes in response to processor 120 executing sequences of instructions contained in memory 130. Such instructions may be read into memory 130 from another computer-readable medium, such as storage device 150, or from a separate device via communication interface 180. It should be understood that a computer-readable medium may include one or more memory devices or carrier waves. Execution of the sequences of instructions contained in memory 130 causes processor 120 to perform the acts that will be described hereafter. In alternative embodiments, hard-wired circuitry may be used in place of or in combination with software instructions to implement aspects consistent with the invention. Thus, the invention is not limited to any specific combination of hardware circuitry and software.

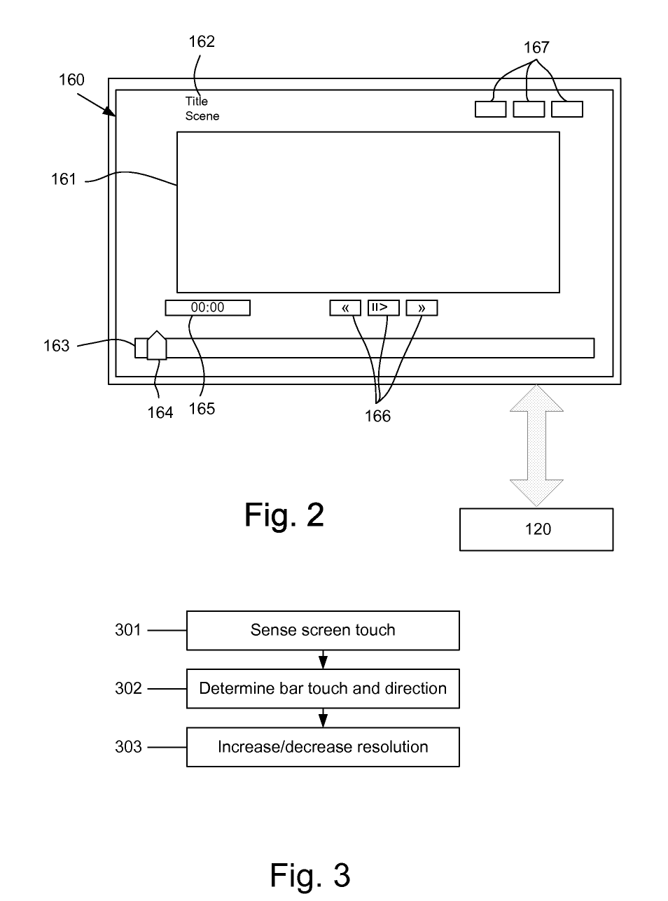

FIG. 2 illustrates a graphical touch-sensitive display 160. Display 160 may include a general purpose display and may be programmed to display content stored in a memory (not shown) associated with the display. Display 160, according to this example, may be configured to show a video, and thus comprises a screen such as video area 161 for rendering or reproducing the video. In an application for playing an audio content, video area 161 may be used for displaying, for example, one or more still images, a slide show, and/or other graphic images, for example, associated with the playing of the audio content.

Information about the content displayed (or played) may be displayed in an information area 162 and/or video area 161, for example, comprising a title of the video and scene no. or any other relevant information. In case of audio media, e.g., name of artist, album, song etc. may be displayed, for example, in an information area 162 and/or video area 161.

Display 160 may further include a visual progress bar 163, in this case configured as an oblong slide bar in the base portion of display 160. Bar 163 may also be arranged in side portions or upper portion (also in mid-portion if not obstructing the content play) of display 160. Bar 163 may be provided with a displaceable indicator, such as a slidable knob 164 which may have at least two functions: showing the progress of the media played and/or initiating fast forward/rewind play of the displayed media.

Field 165 may be functionally connected to knob 164 and move together with knob 164 in one or more directions. Screen field 165 may be configured to provide information about, for example, the elapsed time and/or remaining time of the displayed media. Further control buttons 166 may be arranged for media play control, such as rewinds, play/pause, fast forward, scene selection, etc. Display 160 may also include additional control buttons 167.

Display 160 may be controlled with a driver circuit (not shown) or processor 120. All buttons and bars may be programmed to be visualized via display 160 and the input in form of screen touch is input to the driver (or a special dedicated circuit) and processor 120.

Thus, display 160, using preprogrammed control buttons controls the media play. For example, if play/pause button 166 is touched (i.e., activated), a selected media (stopped or paused) begins playing. Information about the media, such as title, may be displayed in the information area 162. While the media is playing, a user may fast forward, rewind, and/or otherwise change the current play position of the media by means of slidable knob 164.

According to the invention a play position point resolution (precision) increasing/decreasing function is introduced, for example, when the progress bar movement mode has been activated. When a user uses a pointing means (e.g., finger or a pointing device, such as stylus) to manipulate progress bar knob 164, bar knob 164 can be moved in a horizontal direction (along a length of progress bar 163) with a (substantially) 1:1 relation with respect to progress bar 163, but if the user moves the pointing means, alternatively, to move bar knob 164 upwards or a direction other than horizontal (with respect to the length of progress bar 163), the area that the horizontal movement is mapped towards decreases (<1:1 relation). The user may thus fine tune (e.g., search a particular play point in the media with greater precision), for example, a current play point of the media, by moving the pointing means upwards (or other direction than horizontal). If the user moves the pointing means towards the bottom (or an opposite direction of the non horizontal direction) the progress bar resolution (precision) increases towards (i.e., returns to) 1:1 relation.

Of course, the horizontal and other directions mentioned above are given as examples and the directions depend on the position of the progress bar. If the progress bar is arranged on the side portion of the screen, the (normal speed) forward and rewind may be controlled by moving the knob up and down (vertical movement along a length of the progress bar) and the fine tuning will be achieved by a non-vertical, e.g. horizontal, movement. The progress bar may be circular or have another regular or irregular shape.

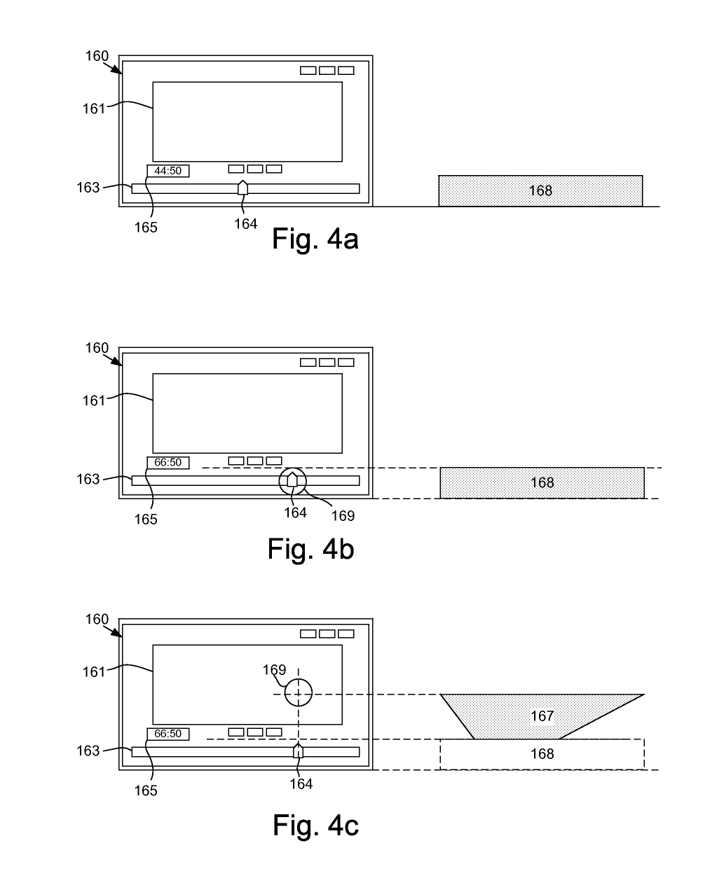

Thus, according to an embodiment of the invention and with reference to FIG. 3, processor may receive information from the touch-screen or the driver circuit that is actuated (301). The positioning of the touched point is assumed to be well known to a skilled person and not described in here in more detail. If it is determined that progress bar 163 is touched the direction is determined (302) and based on the determined direction the speed resolution is set (303).

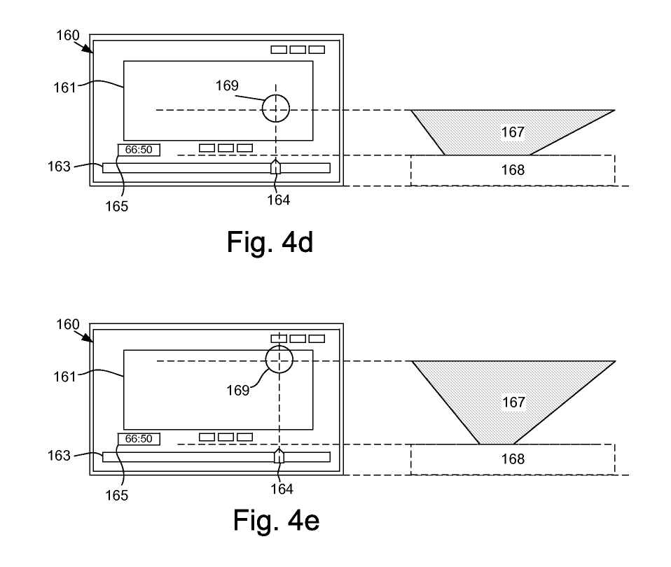

FIGS. 4a to 4e illustrate the display of FIG. 2 in operation. In FIG. 4a, play of a particular media is initiated. The information area shows the elapsed time of the media, i.e., 43:50. Box 168 to the right of the drawing illustrates a corresponding 1:1 (media content search) relation. When the user moves a pointing device (finger, stylus, or the like) in progress bar 163 horizontally, the length of progress bar 163 corresponds to the media that is being played. For example, if the media is 88 minutes long, the user moves the pointing device to be positioned in the middle of progress bar 163 area, the time elapsed should indicate just above 40 min. If accurate, it should be (approximately) 44 minutes.

In FIG. 4b, the media content is fast forwarded to (a time) 66:50. The encircled area 169 illustrates the screen touch by a pointing device, not shown. Box 168, to the right, is still in 1:1 (media content search) relation. When the user positions the pointing device on progress bar 163, the time information increases to indicate that by moving the pointing device the user will alter the position of the media that is being played. The device may be configured to have an altering or active mode, in which the non-horizontal movement is sensed and affects the media play. This mode may be started automatically or initiated by the user or may be media dependent. When the user stops influencing progress bar 163, progress bar 163 may return to a passive mode, for example, indicating playing of the media content corresponding to a current play point. The active or passive modes may also be initiated by the user, for example, by tapping on the screen or chosen in a property setting menu, etc.

In FIG. 4c the pointing means is displaced vertically, in this case perpendicular to progress bar 163. Time played is still indicated as (time) 66:50. The processor now is informed that the fine tuning procedure is activated and sets the fast forwarding function to a relation other than 1:1 illustrated by an area 167. For example, if 10 pixels movement of the pointing means on the screen corresponded to 10 minutes of fast forwarding, the relation is changed, e.g., such that the displacement in vertical direction will reduce the fast forwarding to 5 minutes (corresponding to 10 pixels movement of the pointing means), depending on the vertical distance.

In FIG. 4d, the pointing means is moved horizontally and due to the changed relation a slower fast forward is achieved, which may be shown in information area 162.

In FIG. 4e the pointing means is again displaced vertically and the fast forwarding relation is reduced further, corresponding to more precise (i.e., slower) fast forwarding.

In FIGS. 4a-4e, if the resolution direction is changed, i.e. the pointing means is moved downwards, the resolution (media content search precision) will decrease. With resolution direction is meant the predetermined direction to increase or decrease the fast forwarding/rewinding resolution of the presented media.

FIGS. 5a-5c illustrates schematically one technical aspect of the present invention. The touch sensitive screen may be, for example one of a resistive, capacitive, surface acoustic wave, infrared, optical imaging, strain gauge, optical imaging, dispersive signal technology, acoustic pulse recognition or any other suitable type of touch screen. The operation of a touch screen is assumed well known by a skilled person and not disclosed in detail herein.

In FIGS. 5a-5c, a touch sensing element is denoted with 590. A touch screen may include a huge number of sensing elements in rows and columns. Here, only a small number of elements in a row are illustrated. To simplify the description, irrespective of the type of the touch screen, the touch screen is simplified comprising touch sensing elements.

In operation, with respect to operation of a progress bar, when a pointing device is displaced on the touch sensitive screen, such that a certain displacement Δd, corresponding to displacement of the knob 164, is sensed, it is interpreted to a fast forward or rewind of the media stream. The fast forward or rewind is with respect to a play time. Thus, Δd displacement of the knob corresponds to Δt fast forward/rewind of the media stream. For example, in FIG. 5a, one Δd may correspond to Δt (e.g. 1 sec), i.e. ratio of 1:1.

Applying the present invention on the examples of FIGS. 5a-5c, when the time resolution change mode (active mode) is activated, e.g., by moving the pointing device vertically, a horizontal Δd′(=2×Δd) according to FIG. 5b corresponds to one Δt, i.e., a ratio of 2:1. In this case the pointing device must move twice the distance, according to FIG. 5a, to move one (1) time unit (e.g., 1 sec.) within the media content. Thus, a parameter n may be set to control the ratio between the movement and the time, i.e., Δd=n×Δt or n×Δd=Δt, where n is a number.

In FIG. 5c, another ratio is used: a horizontal Δd according to FIG. 5c corresponds to one Δt′, where Δt′ is e.g., 2 Δt, i.e., ratio of 2:1. In this case the movement of the pointing device corresponds to a two (2) time unit movement within the media content.

Of course, all ratios and directions are given as examples; others may be selected, for example, by a user of the device. The terms “fast forward (play)” and “rewind” as used in this specification refer to “playing” (e.g., advancing) within the media content in a speed (e.g., at a rate) other than a normal play (e.g., viewing) speed.

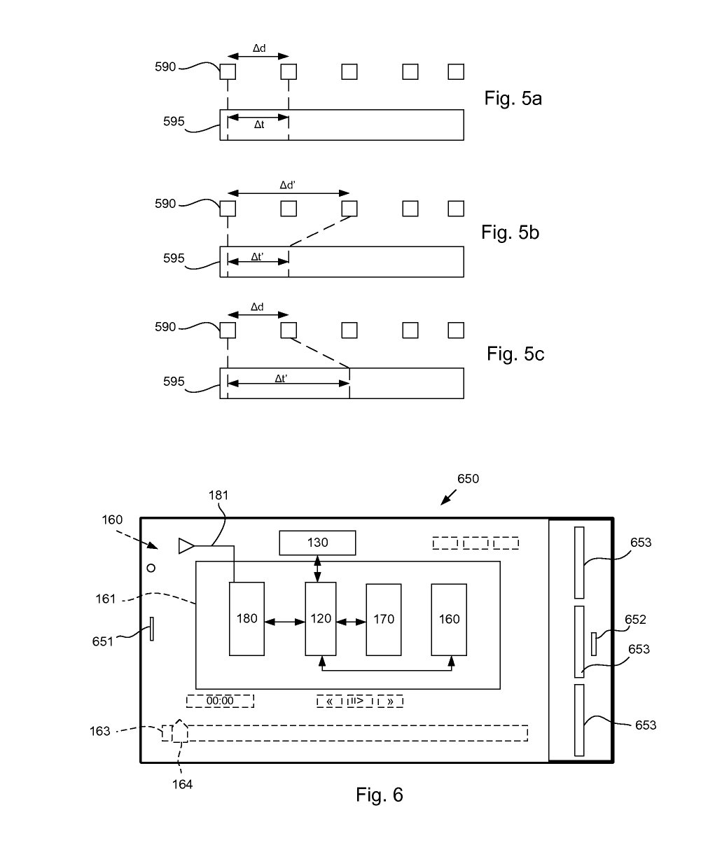

FIG. 6 illustrates a communication device 650 incorporating the present invention. Device 650 may include processor 120, memory 130, read only memory (ROM) 140, storage device 150, input device 160, an output device 170, communication interface 180, and antenna 181. The function of varying parts has been described in conjunction with FIG. 1. Antenna 181 may receive and/or transmit radio signals. Device 650 may also include an ear piece/loudspeaker 651, a microphone 652, and physical control keys 653.

Device 650 may further include graphical touch-sensitive display 160, including screen area 161, information area 162, visual progress bar 163 provided with slidable knob 164 and control buttons 167. The function of display 160 is described in conjunction with FIG. 2.

Further, while series of acts have been described with respect to FIG. 3, the order of the acts may be varied in other implementations consistent with the invention. Moreover, non-dependent acts may be performed in parallel.

It will also be apparent to one of ordinary skill in the art that aspects of the invention, as described above, may be implemented in any device/system capable of displaying a content using a touch sensitive screen.

The graphical representations provided to a user may represent content retrieved locally from system 100. In some implementations, the content may represent content accessed from an external device, such as a server accessible to system 100 via, for example, a network, and streamed to the device, for example, such that the program bar corresponds to a buffered segment or portion of the streamed content. Embodiments of the invention provide for a selected precision with respect to queuing media content to a particular presentation point corresponding to a time parameter associated with a length of the media content. Embodiments of the invention provide an effectively expanded progress bar to the user to allow the user to make incremental movements, on the progress bar (thus within the media content) to a greater degree (i.e., with more precision) than with a progress bar presented in a 1:1 scale. Thus, a user can “jump” to particular points within the media content by scrolling along a locally-expanded progress bar that is presented to the user, a magnitude of which may be selected by the user based on a particular distance from the primary progress bar. The secondary bar can be a selected distance from and substantially parallel to the primary progress bar. In one embodiment, the original indicator may continue to be shown on the primary bar and another indicator may be presented in connection with the secondary progress bar, and movements of the two progress bars may track together and be shown, to the extent that the movement can be discerned on the primary progress bar.

For example, in the implementation described above with respect to FIGS. 1-6, aspects of the invention may be implemented in a mobile terminal/telephone, such as a cellular telephone. In addition, aspects of the invention may be implemented in a digital media player, a camera, a personal digital assistant (PDA), a computer, or any other device with content displaying and touch screen capability. Aspects of the invention may also be implemented in methods and/or computer program products. Accordingly, the invention may be embodied in hardware and/or in software (including firmware, resident software, micro-code, etc.). Furthermore, the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as a processor, a microprocessor, an application specific integrated circuit or a field programmable gate array, software, or a combination of hardware and software.

It should be emphasized that the terms “includes/including” and “comprises/comprising” when used in this specification, are taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the appended claims and their equivalents.

What is claimed is:

1. A method, performed in a device including a touch sensitive display, the method comprising:
controlling, in a first mode, a presentation speed of media content via a display, associated with a first displacement of an indicator, on the touch sensitive display, to produce a change, in the presentation speed of the media content, corresponding to a first ratio relative to the first displacement; and
controlling, in a second mode, the presentation speed of the media content via the display, associated with a second displacement of the indicator, to produce a change, in the presentation speed of the media content, corresponding to a second ratio relative to the second displacement, where the second ratio differs from the first ratio.

2. The method of claim 1, where the second mode is initiated by a user, the media, or automatically.

3. The method of claim 1, where the first and second ratios are represented by, Δt=n×Δd, where:
Δd is a displacement distance of the indicator on the touch sensitive screen,
Δt is a change of time in the media content corresponding to the presentation speed, and
n is a factor for changing the ratio between indicator displacement and rate of presentation speed of the media content.

4. The method of claim 1, where the first and second displacements are performed on an active area of the touch sensitive display, where the active area is displayed as a progress bar related to a length of the media content.

5. The method of claim 4, where the second displacement comprises movement of the indicator in a direction other than along a length of the progress bar.

6. The method of claim 3, where the first displacement comprises movement of the indicator in a direction along a length of a progress bar, and a value of n is 1, and
where the second displacement comprises movement of the indicator in a direction away from the progress bar, and a value of n is based on a distance of the indicator from the progress bar.

7. The method of claim 1, where the presentation speed comprises at least one of fast forwarding or rewinding of the media content.

8. A device comprising:
a touch sensitive display;
a display to present media content;
a first control unit to controlling the touch sensitive display; and
a second control unit to:
control, in a first mode, a presentation speed of the media content via the display, associated with a first displacement of an indicator, on the touch sensitive display, to produce a change, in the presentation speed of the media content, corresponding to a first ratio relative to the first displacement; and
control, in a second mode, the presentation speed of the media content via the display, associated with a second displacement of the indicator, to produce a change, in the presentation speed of the media content, corresponding to a second ratio relative to the second displacement, where the second ratio differs from the first ratio.

9. The device of claim 8, where the device comprises a mobile terminal, a telephone, a digital media player, a camera, a personal digital assistant (PDA), or a computer.

10. The device of claim 8, where the media content includes at least one of audio media or video media.

11. The device of claim 8, where the presentation speed comprises fast forwarding or rewinding of the media content.

12. The device of claim 8, where the media content is provided from an external device.

13. The device of claim 8, where the second mode is initiated by a user, the media content, or automatically.
